(19) United States
(12) Patent Application Publication
(10) Pub. No.: US 2016/0344077 A1
(43) Pub. Date: Nov. 24, 2016

(54) SOLAR DESALINATION AND POWER GENERATION PLANT

(71) Applicant: Farouk DAKHIL, Rome (IT)

(72) Inventor: Farouk DAKHIL, Rome (IT)

(21) Appl. No.: 15/229,410

(22) Filed: Aug. 5, 2016

Related U.S. Application Data
(63) Continuation-in-part of application No. 14/255,404, filed on Apr. 17, 2014.

(51) Int. Cl. H01M 12/02; C02F 3/00; H01M 10/44; H01M 10/36; H02J 7/35; H01M 10/48; H01M 10/46; H01M 2/16; H02J 7/00; C02F 1/14; H01M 10/42

(52) U.S. Cl. CPC H01M 12/02; C02F 1/14; C02F 3/00; H01M 10/441; H01M 10/36; H01M 10/4285; H01M 10/482; H01M 10/46; H01M 2/16; H02J 7/0052; H02J 7/355; C02F 2103/08

(57) ABSTRACT

A system for collecting solar energy and generating fresh water. The system may include a solar energy collection sub-system, a salt water distillation sub-system, and a cooling sub-system. The solar energy collection sub-system may further include one or more solar energy collection assemblies, which may heat a thermally-conductive fluid, which may be used to generate electricity. The salt water distillation sub-system may include a pump, piping, and a distillation cavity. A natural filtration and living flora/fauna sub-system may also be included.

### BACKGROUND

By the year 2025 it is estimated that two thirds of the world population will have limited if any access to fresh water. This scenario is further complicated due to population growth, industrialization, pollution of ground water and climate change.

In addition, the world's population has already exceeded seven billion people and it continues to grow exponentially higher. By the year 2050 we may reach 9.5 billion people. While the planet's population is increasing, we also continue the pollution of lands, rivers, and oceans through toxic emissions, mainly by burning fossil fuels to power heavy industry and vehicles. These are the facts of our daily news and contribute to global warming and climate change.

Perhaps more important to the planet's inhabitants than temperature will be how much rising greenhouse gases crank up the water cycle. It is predicted that precipitation will increase where it is already relatively high—tropical rain forests, for example—and decrease it where it is already low, as in the subtropics. The oceans cover 71% of the globe, hold 97% of its water, and receive 80% of its precipitation. Dry places getting drier would mean longer and more intense droughts, and a stronger need for fresh water in those locations. There is mounting scientific evidence which shows that only a small change in global warming can drastically affect the living conditions of billions of people globally, particularly due to the effect on potential water shortages and all that relies on water, from food to sanitation and public health.

Desalination plants are currently used to create fresh water from salt water, which is commonly sourced from the ocean. A common method used in the desalination process is to filter the water and then use reverse osmosis (RO) to remove the remaining dissolved solids and salts to produce fresh water. However, there are several concerns with desalination because of the potential negative environmental impacts. Electric energy, the main power source for RO desalination plants, results in the emission of air pollutants and greenhouse gases that further exacerbate climate change. Current state-of-the-art RO plants consume between 3 and 4 kWh/m3 of produced water and emit between 1.4 and 1.8 kg CO₂/m3 of produced water. However, this energy requirement does not include the energy needed for intake, discharge, pre-treatment, post-treatment and brine for which additional 1 kWh/m3 is needed. Large RO plants may require an additional and separate power plant just to supply the huge amount of electrical power needed for its function. The additional power plant creates a lot of CO₂ emissions and other pollution, a real negative impact on the environment. The power plant's fuel cells are based on the electrolysis of water into hydrogen and oxygen, then using that hydrogen as fuel, burning it back with oxygen to make energy and water. The problem with using electrolysis of water as fuel is thermodynamics it has to take more energy to split the water in the first place then you can possibly get back by burning the hydrogen back with the oxygen.

Also, before the sea water is pumped through the RO filters at high pressure, it must first be pumped through special filters to eliminate algae and particulates, adding to the energy consumption and costs of the process. Additionally, RO plants cause a hazard to the sea/ocean environment, because the high-speed pumping into the filters can capture and kill many small living organisms, like passing fish.

A solution is needed which can increase self-sufficiency. In particular, the costs of producing clean water heavily tax the environment; there is a need for a low-cost method for meeting those needs on a mass scale.

### SUMMARY

According to at least one exemplary embodiment, a system for collecting solar energy and generating fresh water may be disclosed. The system may include a solar energy collection sub-system, a salt water distillation sub-system, a salt water battery sub-system, and a cooling sub-system. The solar energy collection sub-system may further include one or more solar energy collection assemblies, which may heat a thermally-conductive fluid, which may be used to generate electricity. The salt water distillation sub-system may include a pump, piping, and a distillation cavity. The distillation cavity may be heated in part by the heated thermally-conductive fluid and may be cooled in part by the cooling sub-system. The salt water battery sub-system may include water reservoirs, a charged membrane and a battery. A natural filtration and living flora/fauna sub-system may also be included.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

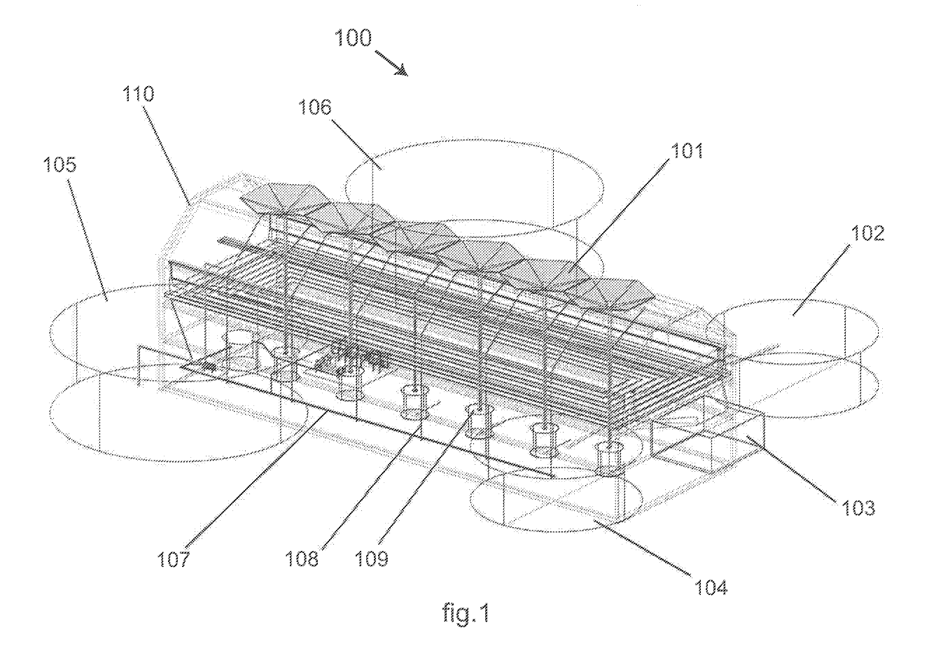

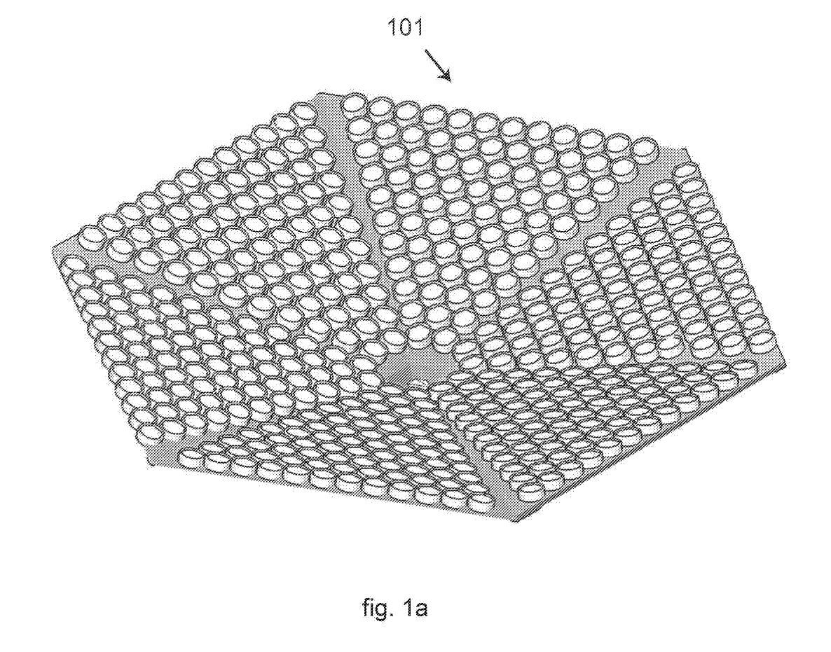

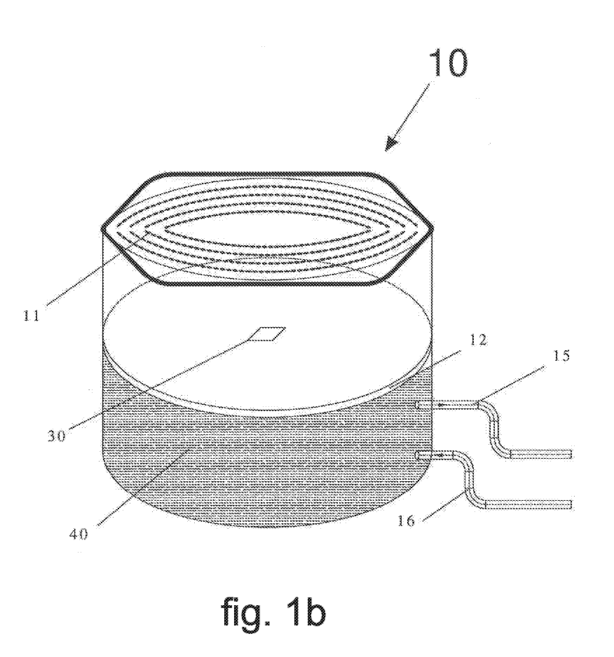

Exemplary FIG. 1 shows an isometric wireframe view of an embodiment

Exemplary FIG. 1a shows a solar energy collection assembly

Exemplary FIG. 1b shows a single solar energy collection unit

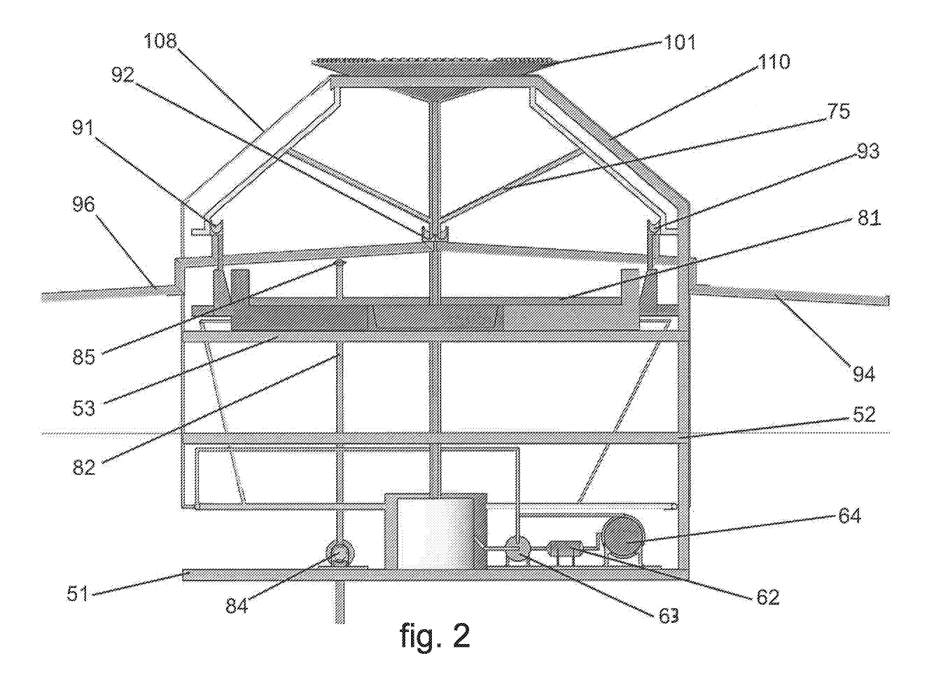

Exemplary FIG. 2 shows a cross-section of an embodiment

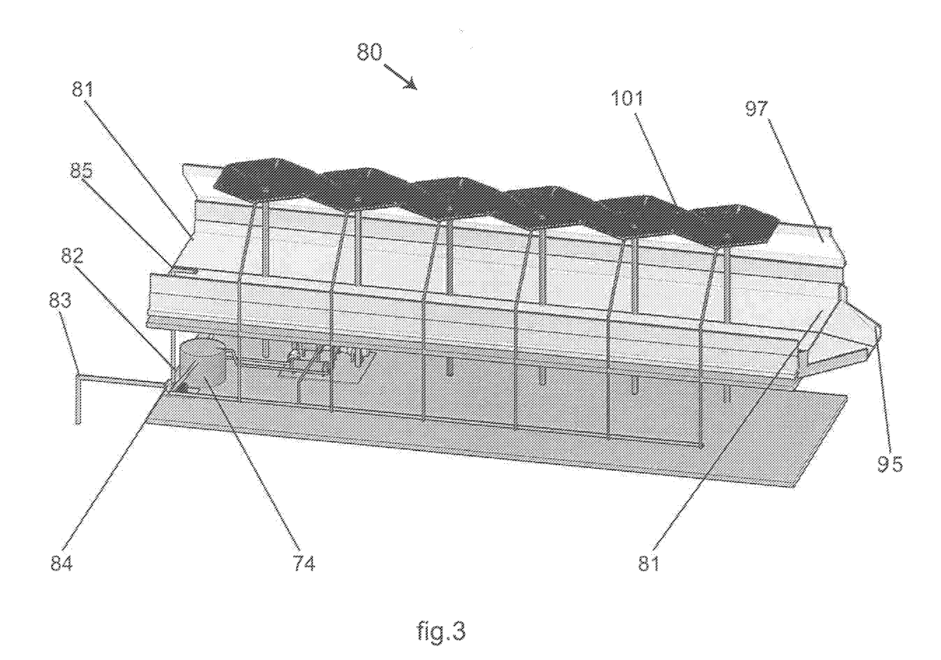

Exemplary FIG. 3 shows a simplified cut-away of a sea water flowing mechanism

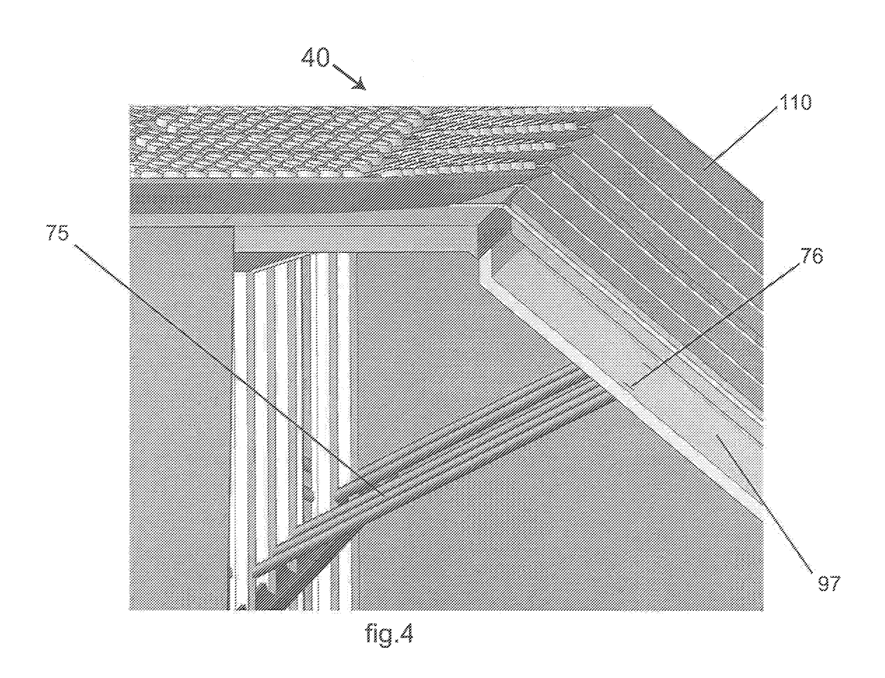

Exemplary FIG. 4 shows a detail of the roof and ceiling of an embodiment

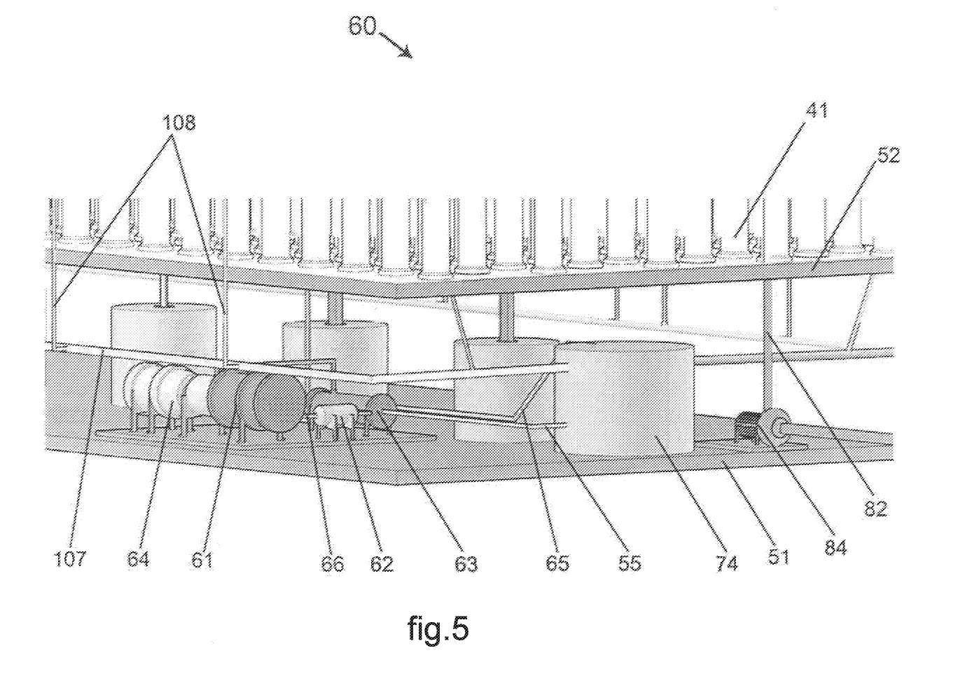

Exemplary FIG. 5 shows a power generation system

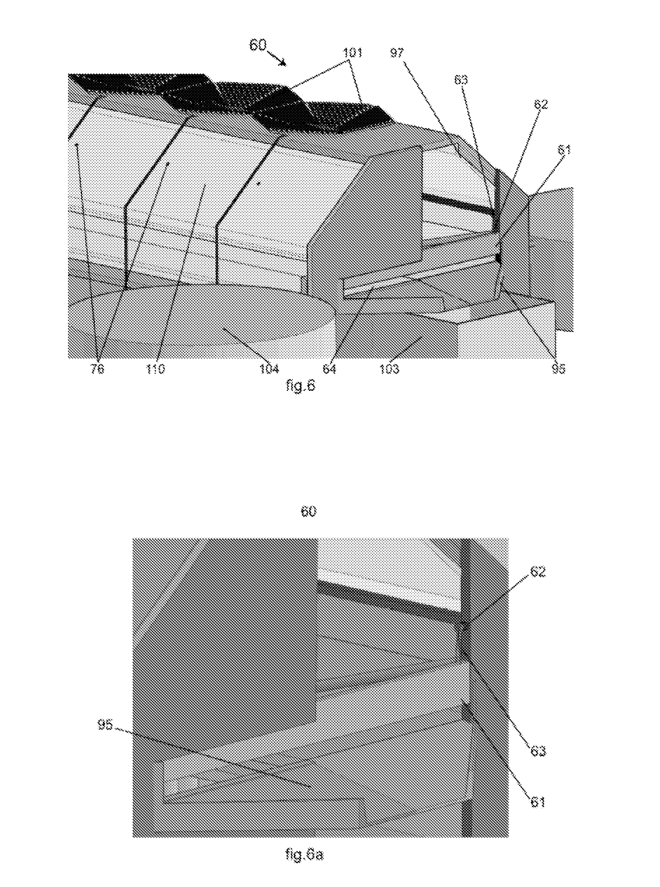

Exemplary FIG. 6 shows an isometric view of an embodiment

Exemplary FIG. 6a shows a sliding door for sea water and salt disposal

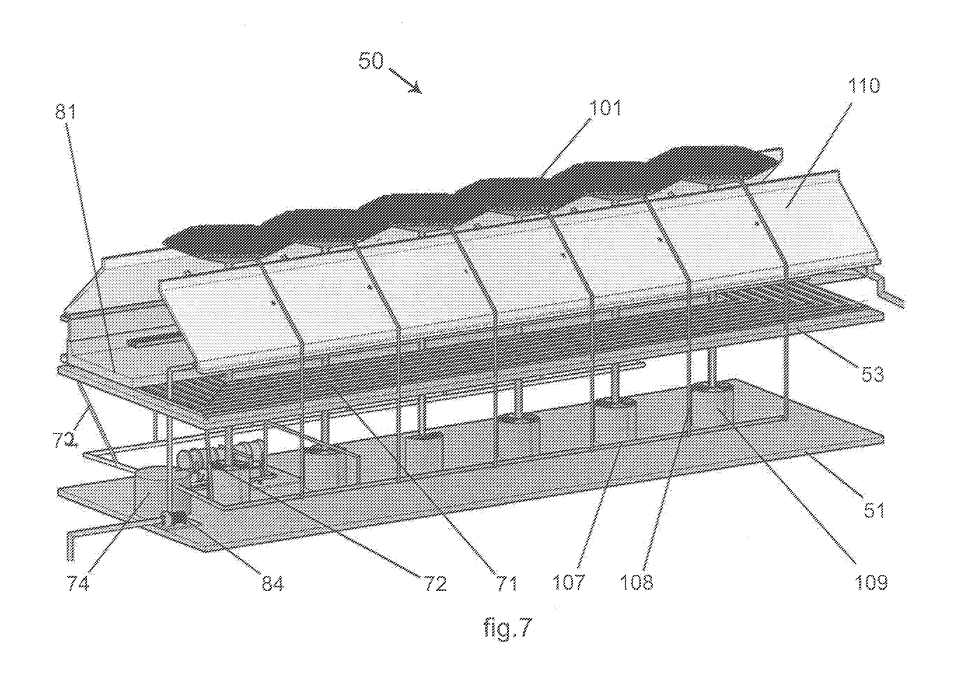

Exemplary FIG. 7 shows a simplified cut-away of a heating system

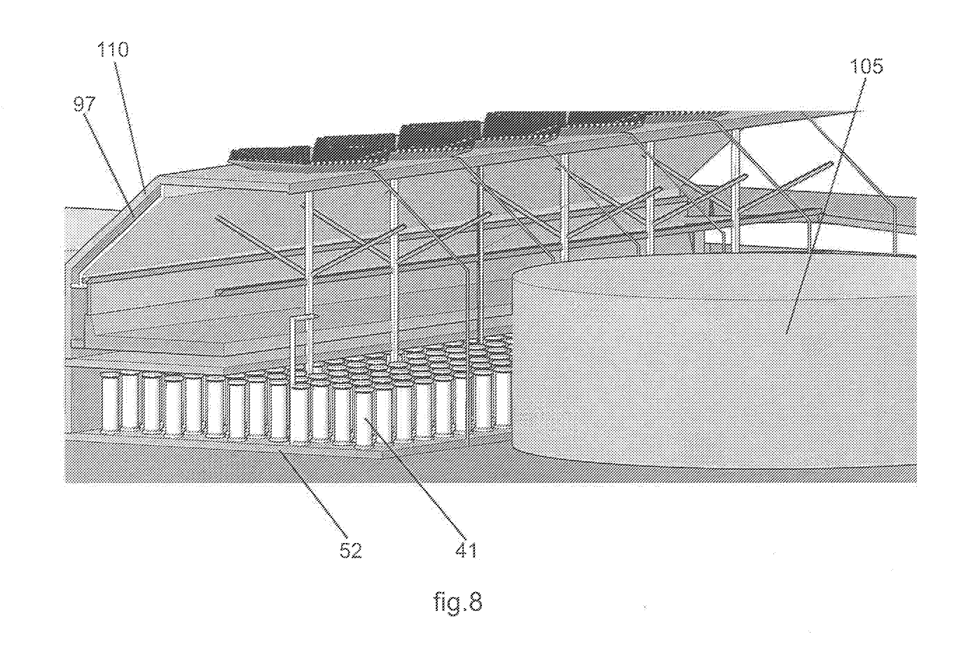

Exemplary FIG. 8 shows a bioreactor assembly

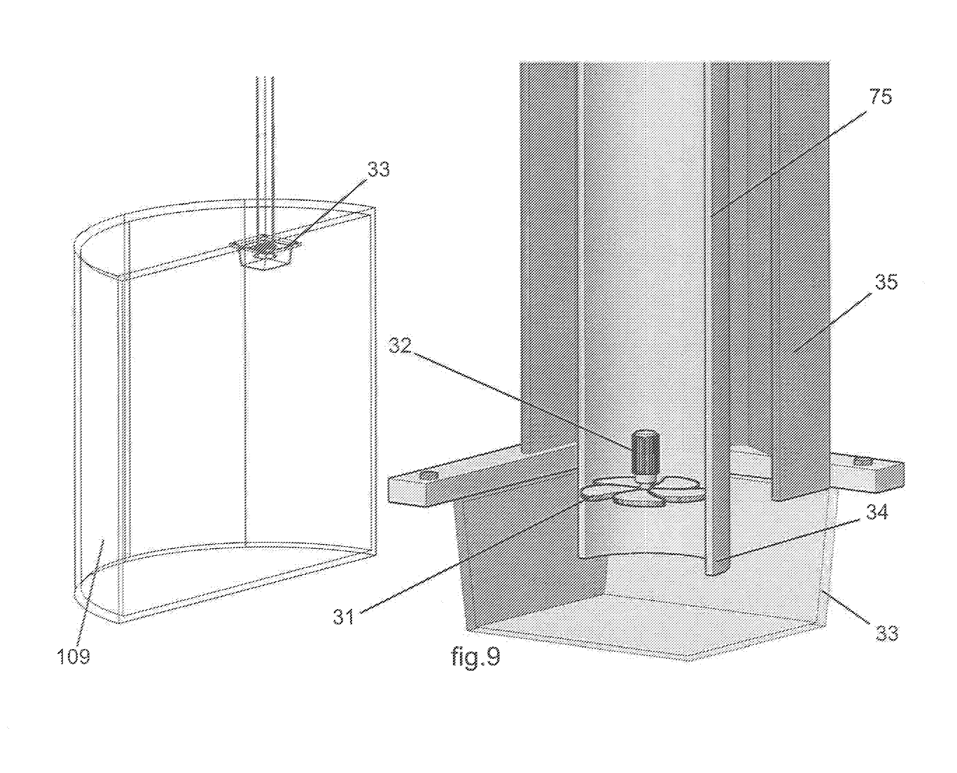

Exemplary FIG. 9 shows a cross-section of a collection tank and ventilator

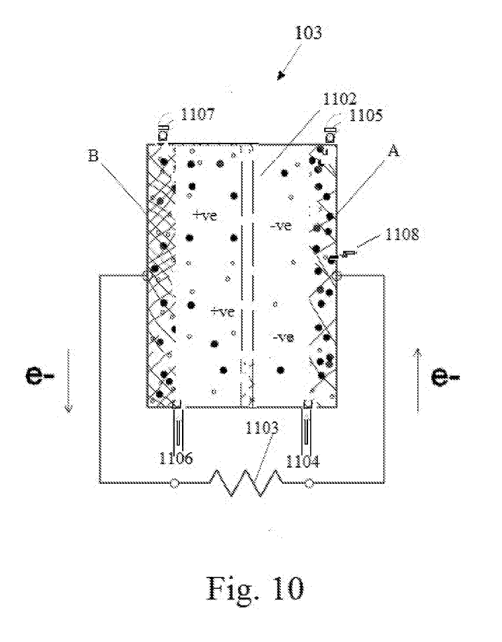

Exemplary FIG. 10 shows a cross-section of a salt water battery assembly

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, a system for collecting solar energy and generating fresh water may be disclosed. The system may include a solar energy collection sub-system, a salt water distillation sub-system, and a cooling sub-system. The solar energy collection sub-system may further include one or more solar energy collection assemblies, which may heat a thermally-conductive fluid, which may be used to generate electricity. The salt water distillation sub-system may include a pump, piping, and a distillation cavity. The distillation cavity may be heated in part by the heated thermally-conductive fluid and may be cooled in part by the cooling sub-system. A natural filtration and living flora/fauna sub-system may also be included.

Referring to exemplary FIG. 1, a solar desalination plant 100 may include one or more solar energy collection assemblies 101, a roof 110 with a slanted component, one or more fresh water collection tanks 102 and 104, and an open interior cavity which may be artificially heated. Each energy collection assembly 101 may include several solar energy collection units in a concave structure, as further described below and shown in exemplary FIGS. 1a and 1b. The open cavity may be defined in part by a floor bed (not shown here) beneath which a heating system may be located, for example a serpentine pipe system, as further described below. The floor bed may be constructed to hold or contain salt water to be purified or distilled. According to at least one embodiment, the heating system is powered by energy collected by the solar energy collection assemblies 101. Roof 110 and/or ceiling of the cavity may be transparent. A small chamber may be located between the roof 110 and the ceiling of the cavity, which may allow for air circulation and cooling of the ceiling to allow the condensation of evaporated water from the floor bed of the cavity. Condensed water may then be collected in a fresh water collection tank 102, 104.

Solar desalination plant 100 may also include one or more fish farms 105, 106. Fish farms 105, 106 may additionally be coupled to one or more algae bioreactors, for example photo-bioreactors (not shown), as further described below. A salt collecting container 103 may contain salt remaining after salt water is evaporated.

A thermally-conductive fluid transport system may include pipes 107 and 108. The thermally-conductive fluid may be, for example, molten salt, a molten salt mixture, thermally-conductive oil, or as desired. According to at least one embodiment, the thermally-conductive fluid may be a molten salt mixture with lithium added to it. In this embodiment, the added lithium may lower the necessary melting temperature of the salt mixture. The thermally-conductive fluid may be heated by energy collection assemblies 101 and transported elsewhere in solar desalination plant 100. For example, heated fluid may provide the heat in the heating system under the floor bed of the interior cavity. Additionally, energy collection assemblies 101, being concave in shape, may allow for the collection of rainwater into containers 109.

Now referring generally to exemplary FIGS. 1a and 1b, an energy collection assembly 101 may include several solar energy collection units 10 in a concave structure. A collection unit 10 may include a concentrating lens 11, a solar photovoltaic (PV) cell 30, and a thermal container 12. Concentrating lens 11 may as thick or as thin as desired for a particular application. Concentrating lens 11 may further be constructed of an acrylic thin-film material, or as desired. Lens 11 may further be constructed of a multiple-micro-lens material. According to one non-limiting example, lens 11 may be constructed of an acrylic thin-film material with a thickness of approximately 0.3175 cm. Additionally, lens 11 may be colored or colorless, as desired, for example to enhance its aesthetic quality, and/or lens 11 may be in any shape, for example a hexagonal shape. PV cell 30 may be located proximate to the focal point of lens 11. Thermal container 12 may be located below lens 11. For example, PV cell 30 may be located on the top exterior surface of thermal container 12. Thermal container 12 may further be painted black. Lens 11, PV cell 30, and thermal container 12 may be constructed in a 1:1 ratio for every collection unit 10 or multiple lenses 11 may be employed for a single thermal container 12, as desired. Lens 11 may be coated with a water- and particulate-resistant material to protect the integrity and functionality of collection unit 10.

In the use of collection unit 10, exemplary temperatures may reach 700-800° Celsius. A thermally-conductive fluid 40 may be used in thermal container 12 to capture and absorb the heat created by concentrating lens 11. Fluid 40 may be conducted to and from container 12 through feeder tube 16 and drainage tube 15. Where multiple thermal containers 12 are used in a single application, thermal containers 12 may be connected in parallel or in series through feeder/drainage tubes 16/15, or as desired. Feeder tube 16 and drainage tube 15 may allow thermally-conductive fluid 40 to flow in a closed-loop system to transfer the heat energy elsewhere to perform work, for example to connect to pipes 107, 108 and heat sea water or produce electricity as elsewhere described. PV cell 30 may produce additional electricity for the solar desalination plant 100, for external uses, or as desired.

Referring to exemplary FIG. 2, different fluid transportation systems in a solar desalination plant 100 may be utilized. Pump 84, which may be located on the basement floor 51, may pump salt or brackish water through tube 82 to opening 85, which may allow salt or brackish water to flow into or onto floor bed 81. Floor bed 81 may contain the salt or brackish water to be distilled. Floor bed 81 may be slightly elevated above a cavity floor 53 so that a heating system may be placed under floor bed 81. Side collection troughs 91, 93 and center collection troughs 92 may collect distilled water inside the interior cavity. Distilled water may be conducted by gravity through one or more pipes 94, 96 to one or more freshwater collection tanks.

Additionally, tubes 75 may conduct collected fresh rainwater to the interior of the structure for collection in one or more containers 109 as described above and shown in exemplary FIG. 1. Collected fresh water may be used in conjunction with thermally-conductive fluid to create electrical power through turbine 64, condenser 62, and heat exchanger 63, as further explained below.

Now referring to exemplary FIG. 3, sea water system 80 may be primarily defined by bed floor 81. Bed floor 81 may be slightly inclined toward opening 95 into a salt collecting container (not shown). Pump 84 may be connected to intake pipe 83. Intake pipe 83 may collect salt or brackish water from any suitable source. For example, intake pipe 83 may be coupled to sand-filtered well to prevent intake of flora, fauna, or unwanted particles, or as desired. Pump 84 may then force salt water up tube 82 to opening 85, which may allow salt or brackish water to flow into or onto floor bed 81.

Exemplary FIG. 4 shows how rainwater collection and cooling chambers 97 may be coupled to tubes 75 through one or more openings 76. Chambers 97 may collect rainwater falling onto the roof 110. Rainwater may then be conducted through openings 76 to tubes 75 and thence to one or more containers 109 (as shown in exemplary FIG. 1). Chambers 97 may also be used as cooling chambers, and may be ventilated by cooled air, for example from containers 109 as shown in exemplary FIG. 9 and further described below. When used as a cooling chamber, chambers 97 may assist in the condensation of water on the ceiling of the interior cavity, thereby assisting the distillation process.

Exemplary FIG. 5 shows a power generation system 60 within a solar desalination plant. Thermally conductive fluid, which may be heated by an energy collection assembly (not shown), may be conducted by pipes 107, 108 into heat exchanger 63. Heat exchanger 63 may accept water, for example water from containers 109, and heat the water to generate water vapor. The water vapor may be conducted to turbine 64, which may rotate an electrical generator 61. Thermally conductive fluid may be stored in container 74, which may help conserve the stored heat in the thermally conductive fluid. Storage may for example take place at night to conserve temperatures until the next day. Stored heat may also be used to generate power at times of little sunlight or as desired. Heat may be stored directly by the thermally conductive fluid or may be stored via heat transfer to another fluid or substance. For example in one embodiment a molten salt may be used as the thermally conductive fluid and the heat storage substance. In another embodiment, thermal oil may be used as the thermally conductive fluid and molten salt may be used as the heat storage substance. Other combinations of the same or different fluids and/or substances may be utilized, as desired. Water vapor leaving turbine 64 may be conducted through tube 66 into condenser 62. Cooled water may then pass back into heat exchanger 63 and restart the process. The electrical energy created by this system may be used to run any of the various electronics controlling the desalination plant and/or be used for external purposes, or as desired.

Now referring to exemplary FIG. 6, on at least one side of a desalination plant a door 67 may be located. Door 67 may be operated by a motor 69 and cord 68, or as desired. Door 67 may open when a certain concentration of salt water inside floor bed 81 in the interior cavity is achieved. When open, highly concentrated salt water or dry salt may move across or through opening 95 and collected in container 103, as shown in exemplary FIG. 1. Collected salt may be utilized for other applications, including a salt water battery or food and industrial applications.

Exemplary FIG. 7 shows how a heating system 50 may be used to heat the salt water located on or in floor bed 81. A thermally-conductive fluid may be heated by solar energy collection assemblies 101 and flow through pipes 107, 108. The thermally conductive fluid may be stored in container 74. The thermally-conductive fluid may also flow through pipe 72 to serpentine 71, which may distribute heat across floor bed 81, thereby heating salt water which may be distilled as described above.

Referring to exemplary FIG. 8, one or more bioreactors 41 may be located within desalination plant 100. Bioreactors 41 may be, for example, algae photo-bioreactors. Bioreactors 41 may be functionally coupled to one or more fish farms 105 (and 106, as shown in exemplary FIG. 1). Fish in the fish farms 105 may be producing excrements used as nutrition for the microorganisms in the bioreactors 41 and the microorganisms may produce oxygen and nutrition for the fish. The bioreactors 41 may also serve as a filtering system for incoming salt or brackish water, whereby the water is passed through the bioreactors to remove various impurities before being pumped onto floor bed 81.

Now referring to exemplary FIG. 9, rainwater container 109 may include a ventilation system. A ventilator 31 with a motor 32 may be placed inside tube 75 proximate to the top of rainwater container 109. A filter 33 may be placed at the opening into container 109 to catch any debris which might otherwise contaminate the stored water. An outer tube 35 may be provided which may allow for the dripping of water down into container 109 without interfering with ventilation air being blown up through a central shaft 34 of tube 75. The cool air from container 109 may be blown up tube 75 to cooling chambers 97 to cool evaporated water vapor and condense it inside the interior cavity.

Now referring generally to all of the above-mentioned exemplary FIGS. 1-9, in construction, the side walls of solar desalination plant 100 may be transparent to allow solar rays to penetrate the structure and help heat the salt water inside the cavity. The slanted portion of roof 110, or the section of the roof covering cooling chambers 97, may have a reflective coating or paint color used to prevent cooling chambers 97 from unduly heating. Floor bed 81 may be constructed of a transparent material, for example to allow sunlight to pass through to nourish bioreactors 41.

In use, the solar desalination plant may combine several systems to work efficiently. A solar energy capturing system may heat a thermally-conductive fluid which may be used in conjunction with a heat exchanger to drive a water vapor turbine, which in turn may drive a generator. The electricity from the generator may power the desalination plant. The plant may have a salt water intake, and utilize a distillation cavity heated by the thermally conductive fluid to distill fresh water, which can then be stored or transported away, or as desired. Cooling for the distillation process may be accomplished through the use of cooling chambers cooled by ventilators located in cool rainwater cisterns. Prior to being distilled, the salt water may first undergo a natural filtration process in controlled bioreactors containing microorganisms, which themselves may be kept in balance with a fish farm.

According to at least one embodiment, an integrated solar desalination plant may function using some or all of the above-described systems to work at a high efficiency of fresh water production, power generation, and sustainability. Such an embodiment may be capable of producing fresh water at a comparable throughput to conventional reverse osmosis desalination plants.

Now referring to exemplary FIG. 10, tank 103 may have an additional compartment that is divided by a membrane 1102 into two compartments. In some exemplary embodiments, membrane 1102 may be graphene-polymer, or another suitable material, as desired. Compartment A may hold highly concentrated saltwater from the reservoir in tank 103, and may be brought in, for example in the, through a pipe and collection area. In this exemplary embodiment, concentrated salt water can be brought by in where a barrier is pulled upward by a pulley mechanism to allow residual high concentrated salt water to flow down by gravity to container 103 via opening 95 through pipe 1104 that may be made of a material substantially inert to salt water. In this case then into compartment A of the new divided tank 103 as shown in FIG. 10. However, the residual seawater may not be totally evaporated in the embodiment 100 but concentrated salt water is then allowed to flow through slope 95 into tank 103. Compartment B may hold, for example, desalinated fresh water from tanks 102 or seawater, for example to save desalinated water for use otherwise, and may be brought in by a pipe such as pipe 1106 that may be made of a material substantially inert to salt water, similar to the above embodiments. Membrane 1102 may be only a few nanometers thick, for example 1-5 nm thick, and may be made of only few layers that may keep the membrane 1102 standing or otherwise secured in place and allowing only salt ions to cross through the membranes 1102 pores, grid-like in structure, porous at the ion-scale and negatively charged by an external source of power (such as a battery), to move positive salt ions or other ions from compartment A to compartment B. The membrane material 1102 may be sufficiently porous to allow salt ions to flow from compartment A to compartment B until an equilibrium state of concentration or another balance is reached, as measured by a sensor 1108, which may use the capacitance of the water, or any other method known to those skilled in the art to measure salinity. When salt equilibrium is reached, compartments A and B are emptied and replenished. The emptying and replenishing of compartments A and B may be controlled through a sensor 1108 that may control a solenoid and piping, for example actuating a valve or valves for the flow of water. The sensor 1108 may register the concentration of the salt in grams/liter, thereby when concentration in compartments A and B are equal or near equal, the sensor could trigger a solenoid valve that could first empty the two compartments of salt water that have reached equilibrium and another solenoid valve could allow new concentrated salt from above opening 95 to replace emptied salt water into compartment A. Into compartment B there could be two options: either fresh desalinated water is obtained from tank 102 or 104 or the less concentrated seawater from the sea may be pumped in as it is pumped into compartment B substantially simultaneously. Current may then flow as in a liquid battery assembly from compartment A to compartment B and load may be directly used or stored in a battery 1103. Placing or coupling a positive electrode and negative electrode (formed, for example, of gold, silver, carbon nanotubes or any other desired materials) on opposite sides of the compartment A and compartment B may create a high power density electricity generating device. The power density may be high (about 1.2 watt/cm²). The voltage supplied by the system may be estimated using the difference in salt concentrations in compartments A and B using this equation: V=k(Sₕ−S₁). Where V is the voltage produced, k is a constant related to the conductivity of electrical current of salt water, Sₕ is the salt concentration in grams per litre of the high concentration inside compartment A, and S₁ in grams per litre is the lower salt concentration value in compartment B. From this equation it can be seen that the voltage is directly proportional to the salt concentration gradient difference in the two compartments A and B. As a result the overall power produced is given by the equation P=V×I, where P is the power produced, V is the voltage, and I is the current. The energy needed for the power generation inside a salt water battery, from a thermodynamic point of view, can be derived from the energy stored in the concentrated salt-seawater during the evaporation inside the solar desalination plant 100 in the form of heat.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for producing electricity, comprising:
a first battery comprising a first compartment for holding salinated water at a first salination level and a second compartment for holding salinated water at a lower salinity level than the first compartment;
a membrane that facilitates charged ions passing there through;
a first electrode, the first electrode coupled to the first compartment;
a second electrode, the second electrode coupled to the second compartment;
a second battery for storing generated electricity;
a generator that charges the membrane;
at least one sensor that measures salinity in at least one of the first compartment and the second compartment; and
at least one pipe that facilitates filling at least the first compartment with salinated water;
wherein the first battery uses an electrical charge on the membrane to alter an electrical charge in the first compartment and the second compartment, and
salt ion concentrations charge the first battery until an equilibrium state is reached in the first compartment and the second compartment.

2. The system for producing electricity of claim 1, further comprising at least a second pipe that facilitates removal of water from at least one of the first compartment and the second compartment.

3. The system for producing electricity of claim 1, wherein the membrane comprises graphene.

4. The system for producing electricity of claim 1, wherein the first electrode and the second electrode and the second battery are connected to form an electrical circuit.

5. The system for producing electricity of claim 1, wherein at least one pipe is opened or closed by control of a solenoid.

6. A method for the production of electricity, comprising:
filling a first compartment with a liquid solution that is supplied by at least one first pipe which is open until the at least the first compartment is filled to a predetermined level, whereafter the at least one first pipe is closed;
filling a second compartment with a liquid solution that is supplied by at least one second pipe which is open until the at least the second compartment is filled to a predetermined level, whereafter the at least second pipe is closed;
charging a membrane disposed between the first compartment and the second compartment;
facilitating particles to move from the first compartment to the second compartment through the membrane;
charging a battery where the current is generated by the conductivity difference between the first compartment and the second compartment conducted through an electrical circuit coupling the battery with the first compartment and the second compartment;
measuring salinity the liquid solution in at least one of the first compartment and second compartment using a sensor;
opening at least one third pipe to remove the liquid solution from the first compartment;
closing the at least one third pipe to seal the first compartment;
removing the liquid solution from the first compartment, where a liquid solution is flows through at least one third pipe which is open until the first compartment is empty, whereafter the at least third pipe is closed; and
removing the liquid solution from the second compartment, where a liquid solution flows through at least one fourth pipe which is open until the second compartment is empty, whereafter the at least fourth pipe is closed;

7. The method for producing electricity of claim 6, wherein the battery is charging by allowing current to flow from the first compartment through a battery into the second compartment.

8. The method for producing electricity of claim 6, wherein the removing of the liquid solution from the first compartment and the second compartment is controlled by the sensor measuring salinity.

9. The method for producing electricity of claim 6, wherein a liquid solution flows continuously through at least one of the first, the second, the third, and the fourth pipes.

10. The method for producing electricity of claim 6, wherein the liquid solution is salt water.
